(19) United States
(12) Patent Application Publication
(10) Pub. No.: US 2014/0229502 A1
(43) Pub. Date: Aug. 14, 2014

(54) Automatic assignment of a search region to a search query

(71) Applicants: Frank Josefiak, Bonn (DE); Filip Petkov, Köln (DE)

(72) Inventors: Frank Josefiak, Bonn (DE); Filip Petkov, Köln (DE)

(73) Assignee: Deutsche Post AG, Bonn (DE)

(21) Appl. No.: 14/255,281

(22) Filed: Apr. 17, 2014

Related U.S. Application Data
(63) Continuation of application No. PCT/EP2012/070623, filed on Oct. 18, 2012.

(30) Foreign Application Priority Data
Oct. 20, 2011 (EP) 11185885.8

(51) Int. Cl. G06F 17/30

(52) U.S. Cl. CPC G06F 17/30424; G06F 17/30241
USPC 707/769

(57) ABSTRACT

The invention relates, inter alia, to a method, a device, a system, a program and a storage medium for selecting one or more sets of logistics data from one or more data sources in accordance with at least one search criterion and a search region. A mobile position is or can be assigned to each of the sets of logistics data, and only sets of logistics data to which the search criterion applies and the assigned or assignable position of which lies in the search region are selected.

### CROSS-REFERENCE TO RELATED PATENT APPLICATIONS

This patent application is a continuation of PCT/EP2012/070623, filed Oct. 18, 2012, which claims priority to European Application No. 11185885.8, filed Oct. 20, 2011, the entire teachings and disclosure of which are incorporated herein by reference thereto.

### FIELD OF THE INVENTION

The invention relates, inter alia, to a method, an apparatus, a system, a program and a storage medium for selecting one or more logistics data records, in particular through the use of semantic search techniques.

### BACKGROUND OF THE INVENTION

The (real-time) monitoring of consignments and/or transport units for the transport of consignments has recently become increasingly important. For this purpose, the consignments and transport units are, for example, equipped with electronic devices which can detect parameters relevant to the monitoring and can transfer them wirelessly (for example via a mobile radio network) to a database of a database server, from which they can be retrieved, for example, by the logistics company responsible for the consignment or the customer. Scan positions can also be provided to track consignments; as soon as a consignment passes such a scan position, the scan position is stored in a database, for example, as the last known position of the consignment.

In order to monitor the consignments and/or transport units of a logistics company, a dispatcher of the logistics company can, for example, submit to the database a corresponding search query in which the consignment or transport unit is identified. As a result of the search query, the positions of the consignments and/or transport units of the logistics company, for example, are then displayed to the dispatcher as a table with address details of the respective scan positions which the respective consignment and/or transport unit has already passed, for example with a time indication, respectively, which indicates when the respective scan position was passed, and/or on a map.

However, a dispatcher is often interested only in information relating to consignments and/or transport units in a specific geographical region and therefore only selects a map extract corresponding to the region in order to display the results of the search query. Consequently, only a part of the information obtained as the result of the search query may be displayed to the dispatcher, or the map extract is automatically shifted or enlarged to display all results. This is disadvantageous, inter alia, since the processing of the search query by the database system requires more computing time than would have been necessary for determining the information actually required by the dispatcher. This is disadvantageous particularly in the case of servers and/or computer clouds in which many users can simultaneously access the database services. Furthermore, the automatic changing of the map extract is not very user-friendly and can result in further map extracts having to be made available (in some cases at a cost) by a map service provider.

### SUMMARY OF THE INVENTION

The object of the present invention is therefore, inter alia, to overcome the aforementioned disadvantages.

The object is solved by a method according to claim 1, an apparatus according to claim 13, a system according to claim 14 and a program according to claim 15. Further embodiments can be found in the dependent claims.

An example of a method according to the invention, carried out by at least one apparatus, comprises obtaining and/or determining a search criterion for a search query of a user, automatically assigning and/or determining a search region for the search query, selecting of one or more logistics data records from one or more data sources in dependence on at least the search criterion and the search region, wherein a mobile position is assigned or assignable to each of the logistics data records, and wherein only logistics data records are selected to which the search criterion applies and the assigned or assignable position of which is located in the search region, and outputting information relating to the selected logistics data records as a result of the search query.

The method according to the invention can be carried out by one or more data-processing apparatuses. Examples of a data-processing apparatus are a computer, a personal computer, a portable computer, a thin client, a personal digital assistant, a mobile telephone and/or any other electronic device which has at least one processor.

In particular, the method according to the invention can be carried out by one or more servers, for example by one or more servers of a search service provider for logistics data. The method can also be carried out by the servers and by at least one client connected to the servers. A server is to be understood to mean, in particular, a data-processing unit in a network which communicates via the network with one or more data-processing units, the clients, in order to provide them with special services and/or computing power. In a client-server architecture of this type, the special services provided by the server and/or the computing power can be used by a plurality of clients so that the clients themselves, for example, have to retain less own computing power. A server and a client can designate both a data-processing apparatus and a program which is executed on the data-processing apparatus. The network is, for example, a local area network, a wide area network, a virtual network, a radio network, a telephony network and/or the Internet. The communication is effected, for example, in a wireless or wirebound manner.

The servers may, for example, be database servers. Examples of a database server are a Microsoft SQL Server, an Oracle server and a MySQL server. The servers may, for example, be part (for example a “component”) of a so called computer cloud which makes data-processing resources available dynamically to different users via a network. A computer cloud is intended to be understood to mean, in particular, a data-processing infrastructure according to the definition of the “National Institute for Standards and Technology” (NIST) for the English term “Cloud Computing”. An example of a computer cloud is a Microsoft Windows Azure Platform.

A mobile position is understood to mean, in particular, a variable position of a mobile unit, for example a consignment or a transport unit. Examples of a consignment are a letter, a registered letter, a package, a parcel or a freight delivery. Examples of a transport unit are a heavy goods vehicle (HGV), a car, a ship, an aircraft, a transporter, a train, a railway carriage, a container and a swap body.

The mobile position of a mobile unit may, for example, be updated at regular time intervals in a database. The mobile position of a mobile unit may, for example, be updated at irregular time intervals in a database, for example only when the mobile position of the mobile unit changes. A mobile position may, for example, be stored in a database in the form of position coordinates, such as geographical latitude and longitude data or position coordinates of a satellite navigation system (e.g. the Global Positioning System (GPS) or the Galileo system, e.g. position coordinates according to the World Geodetic System 1984 reference system) or a mobile radio system. The database is, for example a position database, a vehicle fleet database, a telematics database, a consignment-tracking database and/or a logistics database. The mobile position may, for example, be a current position of the mobile unit, or the last known position of the mobile unit or a historical position of the mobile unit.

A data source is to be understood to mean, in particular, a database such as a position database, a telematics database, a vehicle fleet database, a consignment-tracking database and/or a logistics database. However, a data source may also be a vehicle's own position transmitter and/or stationary or mobile consignment control stations (e.g. to record scan positions).

A logistics data record comprises, for example, geo-based information. A logistics data record is, for example, assigned to one or more mobile units, the position(s) of which is/are assigned or assignable to the logistics data record. A position is assigned or assignable to a logistics data record, for example, if the logistics data record comprises the position or a reference to a data record with the position. The data record with the position is, for example, stored in a different database than the logistics data record.

For example, the logistics data record may comprise one or more parameters of the assigned mobile units. Examples of parameters of a mobile unit are an identifier of the mobile unit, the consignment type, the transport unit type, an identification of the responsible logistics company, one or more time-related criteria, the current speed, the average speed, the present CO₂ emission, the temperature, the relative humidity, the starting address, the destination address, the planned route, the loading, the current mobile position and/or the preceding mobile positions.

The search criterion for the search query of the user relates, for example, to one or more of the parameters, in particular a linking of a plurality of parameters is also conceivable. For example, the search criterion applies only to logistics data records which are assigned to transport units of a specific forwarding agent or consignments with a specific destination address.

The search criterion is obtained, for example, by means of a user input. In a client-server architecture, the search criterion is entered, for example, by the user on a client and is transferred from the client to one or more servers of the search service provider as a search query of the user.

The search criterion can also be determined at least partially automatically. For example, the search criterion can be adapted automatically to user data, for example, from a user database and/or a user account. For example, the search criterion is automatically linked to a parameter in such a way that it applies only to logistics data records which the user is authorised to view. A user is authorised, for example, to view only those logistics data records which are assigned to consignments for which the logistics company of the user is responsible, and/or to transport units of this logistics company. The search criterion may, for example, be adapted only to user data (or a subset thereof) in respect of the use of which the user has declared his agreement.

The search region is, for example, a geographically limited region, for example at least a part of the earth's surface, for example a part of the earth's surface defined by political boundaries, such as a national territory. In particular, the geographically limited region can be smaller than the entire earth's surface, i.e., for example, only a part of an entire region presentable on a world map. The search region may be assigned to the search query, for example, by a linking of the search criterion to a representation of the search region. A representation of the search region is, for example, a closed coordinate line, a radius around a position and/or an interval of corresponding geographical latitude and longitude data. The search region is, for example, an at least essentially rectangular region, for example a square in the Euclidean or in a non-Euclidean geometry.

The search region is assigned automatically to the search query. For example, the search region of the search query is automatically determined for the user and allocated to the search query. The automatic assignment and/or determination of the search region is preferably effected without the user limiting the search query at least expressly to a geographical region. For example, the search region is geographically limited to a region in which the user is, at least with a high probability, interested. For example, the search region is automatically determined from a map extract displayed to the user, the current position of the user, a predefined search region and/or previous search querys of the user. For example, the automatic assignment is effected as soon as the user has retrieved or modified the displayed map extract and/or as soon as the user has initiated a new search query or has reset a search query. A predefined search region and/or the previous search querys of the user may, for example, be determined from user data from a user database. This is advantageous, inter alia, in order to reduce the information output as the result of the search query to information which is, at least with a high probability, of interest to the user.

In a client-server architecture, the automatic assignment and/or determination of the search region can be effected, on the one hand, on the client side and, on the other hand, on the server side. For example, the client can automatically record the current position of the user, geographically limit the search region to a predefined radius around this position and assign this search region to the search query of the user. For example, the client is a mobile telephone which can carry out a GPS location and/or a radio cell localization. For example, the servers can automatically determine the search region on the basis of the previous search querys of the user and assign it to the search query of the user. The search region may, for example, also be automatically geographically limited to a search region predefined by the user and/or the search region most frequently used by the user.

The search query with the search criterion and the assigned search region is transferred, for example, to one or more selection units. The logistics data records can be selected by the selection units, for example by means of a comparison of the search criterion with the parameters comprised by the logistics data records and a matching of the search region with the mobile position assigned or assignable to the logistics data records. The selection units are, for example, database components of a computer cloud and/or database servers or parts thereof.

The logistics data records may, for example, be selected by means of a search with a suitable search algorithm in one or more databases. For example, a search engine with a suitable search algorithm can be used, wherein the search algorithm (or a different unit) indexes, for example, the data, and uses the index or the indexes at runtime for the search query. This is advantageous, for example, if the number of linking operations (known as “JOIN” operations) which may be necessary for the search in the databases is large.

Examples of possible search algorithms are searching in lists, linear searching, binary searching, interval searching, searching in trees, heuristic searching, A*, IDA*, bidirectional search procedures, the minimax method and/or alpha-beta searching. Self-optimising search algorithms, in particular for large data volumes, heuristic search algorithms, evolutionary search algorithms (e.g. self-learning algorithms) and/or TF-IDF (Term Frequency-Inverse Document Frequency) based algorithms can preferably be used.

The selected logistics data records can originate from different data sources, for example from databases of different providers. For example, the logistics data records of transport units may be stored in a different database than the logistics data records of consignments. The positions assigned or assignable to the logistics data records may similarly originate from different data sources, for example from databases of different providers. For example, the logistics data records assigned to the transport units of a logistics company are stored in a telematics database of a telematics service provider as telematics data records. For example, HGV manufacturers offer such telematics services. The logistics data records assigned to the consignments for which the logistics company is responsible are, for example, stored in a consignment-tracking database of the logistics company or of a consignment-tracking service provider as consignment-tracking data records. Information relating to logistics data records from databases of different providers can thus be output as the result of the search query. This is advantageous, inter alia, in order to enable a search across providers and/or databases.

For example, the search query can be processed by database servers of different telematics service providers and/or consignment-tracking service providers. In a client-server architecture, one or more servers of the search service provider can forward the search query, for example to database servers of different telematics service providers and/or consignment-tracking service providers and can summarise the information relating to the logistics data records as the result of the search query from the different databases.

Through the automatic assignment and/or determination of the search region, the search criterion is linked geo-semantically to the search region and the search area covered by the search query is reduced. This is advantageous, inter alia, in order to effectively minimise the number of the logistics data records that are (at least initially) to be searched. Furthermore, this is advantageous, inter alia, in order to reduce the computing time for the processing of the search query (i.e. in comparison with the computing time for the processing of the search query without the geo-semantic linking of the search criteria to the search region).

Through the automatic assignment and/or determination of the search region, for instance a preselection of those logistics data records that have an assigned or assignable position that is located in the search region assigned to the search query can be performed. A preselection can also be made, for example, on the basis of the geographical nature of the search region. For example, ships and containers are located, at least with a high probability, in a search region which is located completely in the Indian Ocean, but no land vehicles, so that the preselection of the logistics data records comprises only logistics data records which are assigned to ships and containers. For example, the preselection limits the search to databases containing logistics data records assigned to ships and containers. Only within the preselection can, for example, logistics data records then be selected to which the search criterion applies. As a result, a computing-intensive and/or time-consuming full-text search must, for example be effected only within the parameters of the already preselected logistics data records. The information output as the result of the search query is, for example, one or more of the parameters comprised by the selected logistics data records and/or the positions assigned or assignable to the logistics data records. The information is, for example, output and/or made available for output by the selection units. In a client-server architecture, the information is output, for example, by a forwarding of the information via the network to the client. By reducing the information that is to be output as the result of the search query, the data volume to be transferred in a client-server architecture can therefore also be minimised. This is advantageous, inter alia, in order to reduce the data traffic necessary for the search query and, for example, to be able to use clients with a slow network connection, such as, for example, General Packet Radio Service (GPRS) connections.

An example of an apparatus according to the invention comprises means for carrying out the method according to the invention. The apparatus is, for example, a data-processing apparatus, for example a server or a client. The apparatus is, for example, a computer cloud.

An example of an apparatus according to the invention comprises, for example, at least one processor, and at least one memory, wherein a program comprising program instructions is stored in the memory, wherein the memory and the program are configured at least to cause the apparatus to carry out the method according to the invention with the processor when the program is executed on the processor. The apparatus is, for example, software-configured in order to be able to carry out the method. Software-configured is intended to be understood to mean, in particular, the preparation of the apparatus which is necessary in order to be able to carry out a method, for example in the form of a program on the processor.

A processor is intended to be understood to mean, inter alia, one or more control units, microprocessors, micro control units such as microcontrollers, digital signal processors (DSP), Application-Specific Integrated Circuits (ASIC) or Field Programmable Gate Arrays (FPGA).

A memory is, for example, a program memory and/or a main memory of the processor. A program memory is intended to be understood to mean, inter alia, a non-volatile memory and a main memory to mean a volatile or non-volatile memory, in particular a random access memory (RAM) and/or a flash memory. Non-volatile memories are for example random access memories (RAM) such as for example NOR flash memories or sequential access memories such as for example NAND flash memories and/or read-only access memories (ROM) such as for example EPROM, EEPROM or ROM memories. The memory may, for example, be of tangible form.

An example of a system according to the invention comprises one or more apparatuses with means for carrying out the method according to the invention. For example, the system comprises one or more apparatuses according to the invention or one or more apparatuses (for example a server and a client) which, taken together, perform the functions according to the invention. For example, a first apparatus can obtain the search criterion and assign the search region to the search query, and a second apparatus can perform the selection of one or more logistics data records and the outputting of information relating to the selected logistics data records. However, these functions can also be distributed differently among the two (or more) apparatuses and/or can also be jointly performed, at least partially, by a plurality of apparatuses.

An example of a program according to the invention comprises program instructions for carrying out the method according to the invention at least partially when the program is executed on a processor. A program is, for example, distributable via a network such as a local area network, a wide area network, a virtual network, a radio network, a telephony network and/or the Internet. A program can at least partially be software and/or firmware of a processor. For example, the program according to invention is stored in a memory of the apparatus according to the invention.

An example of a storage medium according to the invention comprises the program according to the invention. The storage medium is, for example, a computer-readable storage medium which contains the program according to the invention and is designed for example as a magnetic, electrical, electromagnetic, optical and/or other type of storage medium. The storage medium may, in particular, be a physical and/or tangible storage medium. The storage medium is, for example, portable or permanently installed in an apparatus. The storage medium is, for example, of tangible form. “Computer-readable” is intended to be understood, to mean, in particular, that the storage medium can be read (out) or written by a computer or a data-processing apparatus, for example by a processor. The storage medium is, for example, a program memory of a processor.

Example embodiments of the present invention are described below, referring to further examples of features of the method according to invention, the apparatus according to the invention, the system according to the invention, the program according to the invention and the storage medium according to the invention. In particular, corresponding means to carry out the method step of the apparatus according to the invention and a corresponding program instruction of the program according to the invention are also intended to be regarded as disclosed through the description of an additional method step of the method according to the invention. The same is intended to apply to the disclosure of a means for carrying out a method step or a program instruction, for example the disclosure of a means to carry out a method step is also intended to be understood as the disclosure of the corresponding method step and a corresponding program instruction.

According to an embodiment of the method according to the invention, the search region is determined from a map extract displayed to the user, for example from the map extract which is displayed at the time of input of the search criterion by the user. For example, the search region is determined in such a way that it corresponds to at least a part of the displayed map extract. For example, the search region corresponds to a geographically limited region in the centre of the displayed map extract.

For example, the search region can be determined before the map extract is displayed or is made available for display to the user and before the input of the search criterion by the user. For example, the search region and/or the map extract can be predefined by default for the user and can, for example, be stored in the user data. For example, the search region can be determined by default as a region with a predefined radius around a known/located position of the user. The displayed map extract is then, for example, a map extract automatically displayed to the user, for example the map extract displayed by default and or a map extract around the known/located position of the user.

For example, the search area can be determined by the user following the input of the search criterion, for example from the map extract displayed or made available for display at this time, for example when the user has selected and/or modified the displayed map extract.

A map extract is intended to be understood to mean, in particular, a graphical representation of a part of the earth's surface, preferably a true-scale representation. A map extract contains, for example, at least a correctly oriented representation of a part of the geographical objects located on the part of the earth's surface, such as roads, railway lines, larger buildings, the outlines of built-up areas and/or other technical features such as (political) boundaries, water or power lines. Examples of map extracts are roadmaps, nautical maps and topographical maps.

The interest of a user who submits a search query when a specific map extract is displayed to him relates, at least with a high probability, to information concerning logistics data records, the assigned or assignable position of which is located in the map extract. For example, a user who is interested in information relating to all consignments in a specific region will (e.g. subconsciously or consciously) select a map extract corresponding to the region and will start a corresponding search query, for example by entering a corresponding search criterion (e.g. consignments only). Here, a search region corresponding to the displayed map extract is automatically assigned to the search query so that (at least initially) only logistics data records are selected which are assigned to consignments, the assigned or assignable positions of which (e.g. their searched position and/or their respective last known position) are located in the geographical region represented by the map extract. This is advantageous, inter alia, in order to link the search query geo-semantically to a search region that is, at least with a high probability, of interest to the user, and in order to minimise the number of logistics data records that are (at least initially) to be searched.

According to an embodiment, the method according the invention furthermore comprises displaying the map extract for the user. For example, the map extract is displayed to the user on a user data processing apparatus. The map extract may, for example, be stored on the user data processing apparatus, for example as a displayable graphic. In the client-server architecture, the map extract can be displayed to the user, for example, on a client. For example, the map extract can be made available for display to the client by a server of the map service provider and/or of the search service provider, for example as a displayable graphic.

According to an embodiment of the method according to the invention, the map extract contains a known position of the user. The map extract is, for example, centred around the known position of the user.

For example, the known position of the user is a mobile position which is determined by a location method. Examples of possible location methods are Internet Protocol (IP) location, mobile radio location (e.g. Global System for Mobile Communications (GSM) or Universal Mobile Telecommunications System (UMTS) location), radio network location and/or satellite location (e.g. GPS location or Galileo location). In a client-server architecture, the location can be carried out, for example, on the client side and/or on the server side.

The known position of the user may, for example, also be a fixed position, so that the same map extract is always displayed by default to the user. The fixed position may, for example, be stored in a user database of the map service provider and/or the search service provider.

According to an embodiment of the method according to the invention, the map extract is selectable and/or modifiable by the user. In particular, the map extract may be selectable and/or modifiable by the user before the assignment of the search region to the search query. For example, the user can move, reduce or enlarge the map extract. If the map extract is modified following the input of the search criterion, the search region can, for example, again be determined from the modified map extract. In addition, a new search query based on the entered search criterion and the newly determined search region can then be instigated automatically, for example, and one or more logistics data records can be selected accordingly.

According to an embodiment of the method according to the invention, the search region is determined automatically and in such a way that the centre of the search region corresponds to the centre of the map extract. This is advantageous, inter alia, in order to centre the search region around a position which is, at least with a high probability, of interest to the user. The search region is then located, for example, in a predefined or dynamically determined radius around the centre of the map extract.

According to an embodiment of the method according to the invention, the search region is determined automatically and in such a way that the search region corresponds to the map extract. For example, the search region is determined automatically and in such a way that the search region corresponds to the currently displayed map extract. The search region is then, for example, determined automatically from the map extract displayed at the time of the start of the search query, for example when the search criterion is entered. This is advantageous, inter alia, in order to link the search query geo-semantically to a search region which is, at least with a high probability, of interest to the user.

According to an embodiment of the method according to the invention, the information relating to the logistics data records is displayed on the map extract at the position assigned or assignable to the respective logistics data records, respectively. It can thereby be avoided, for example in a client-server architecture that further map extracts have to be provided, for example by a server of a map service provider or of the search service provider for display by the client. This is advantageous, inter alia, in order to reduce the necessary data traffic and, for example, to enable the use of clients with a slow network connection. The provision of (further) map extracts by a server of a map service provider or of the search service provider may also be subject to a cost.

For example, a pictogram corresponding to the respective logistics data record is displayed at the position assigned or assignable to the respective logistics data record. Examples of possible pictograms are an HGV pictogram, a ship pictogram, a container pictogram, a swap body pictogram, a letter pictogram and/or a parcel pictogram. Along with a pictogram, further parameters comprised by the logistics data record, for example, may be displayed or may be activated for display, for example by a user input. For example, the display of the information is updated at regular intervals, so that a movement of the mobile units assigned to the logistics data records is also presentable. The preceding positions may, for example, similarly be displayed and/or be activated for display, for example through a user input. The planned route may, for example, similarly be displayed and/or be activated for display, for example by a user input. This is advantageous, inter alia, in order to enable a clearly presented and user-friendly output of the information.

According to an embodiment of the method according to the invention, further information respectively relevant to the selected logistics data records is displayed on the map extract. For example, traffic, weather, airport and/or seaport information is displayed in the respective environment of the respective positions of the logistics data records. The further information may be selected, for example, depending on the search criterion, the selected logistics data records and/or the search region. For example, only further information which is assigned and/or assignable to a position located in the search region and which is relevant to the selected logistics data records is selected. The further information may, for example, be selected and displayed automatically. The further information may be selected and displayed, for example, on the basis of a user input, for example the user can select that relevant traffic information is to be displayed.

Traffic information is relevant, for example, if at least one of the selected logistics data records is assigned to an HGV. For example, in this case only traffic information for the planned route of the HGV and/or the search region can be selected and displayed. Weather information is, for example, particularly relevant if at least one of the selected logistics data records is assigned to a ship. For example, in this case only weather information for the planned route of the ship and/or the search region can be selected and displayed. Furthermore, for example, in this case seaport information (e.g. transhipment time, free berths and the like) for the planned destination port of the ship can be selected and displayed. As a result, only further information which is, at least with a high probability, of interest to the user is displayed to him. This is advantageous, inter alia, in order to reduce the necessary data traffic and, for example, in a client-server architecture, to enable the use of clients with a slow network connection. The provision of further information may also be subject to a cost, may be time-consuming and/or computing-intensive.

According to an embodiment, the method according to the invention furthermore comprises selecting one or more further logistics data records from the data sources in dependence on at least the search criterion and the search region, wherein a mobile position is assigned or assignable to each of the further logistics data records, and wherein the further logistics data records are selected only if the search criterion applies to them and their assigned or assignable position is not located in the search region. For example, all further logistics data records to which the search criterion applies and of which the assigned or assignable position is not located in the search region are selected. The further logistics data records of which the assigned or assignable position is not located in the search area may, for example, be selected temporally after the selection of the logistics data records of which the allocated or assignable position is located in the search region. For example, the selection of the further logistics data records (located outside the search region) could be started immediately, as soon as the logistics data records of which the respectively assigned or assignable positions are located within the search region are selected. It is also conceivable for the selection of the further logistics data records to be performed, for example, simultaneously, but with a lower priority and/or in the background. In this way, in the computing time which is reduced due to the reduced search area, for instance initially the information which is displayable on the displayed map extract could be output as the result of the search query, as detailed above. After a longer computing period, the further information which is not displayable on the displayed map extract could then be output as the result of the search query.

According to an embodiment, the method according to the invention further comprises outputting information relating to the further logistics data records. For example, the information relating to the further logistics data records is displayed in a representation which differs from the representation for the information relating to the logistics data records. For example, the information relating to the further logistics data records is displayed at the edge of the displayed map extract (for example inside or outside the map extract), for example with an indication of the distance of the position assigned or assignable to the respective further logistics data record from the edge or from the centre of the map. For example, the information relating to the further logistics data records is displayed as a link (for example as a hyperlink). Upon selection of the link, for example by means of a user input, a map extract containing the position assigned or assignable to the further logistics data record (for example centred around said position) can, for example, then be displayed. This is advantageous, inter alia, in order to offer the user an overview of the information not displayable on the map extract.

According to an embodiment, the method according to the invention furthermore comprises automatically extending the search region for the search query if no logistics data record has been selected or the number of selected logistics data records falls below a threshold value, and/or automatically reducing the search region for the search query if the number of selected logistics data records exceeds a threshold value. Examples of a threshold value are, for example, 10, 100 and 1000. In particular, the threshold value is variable, for example the threshold value changes depending on the scale of a displayed map extract (e.g. proportionally). This is advantageous, inter alia, in order to effectively minimise the number of logistics data records that are (at least initially) to be searched and to reduce the computing time for the processing of the search query. Furthermore, a prioritisation in the search, which can, for example, be used in the case of evolutionary search querys (for example in the selection performed therein), can thereby also be enabled.

According to an embodiment of the method according to the invention, the search criterion restricts the selectable logistics data records at least to logistics data records assigned to the user. For example, the search criterion is automatically determined in such a way that only logistics data records which the user is authorised to view are selectable, for example only logistics data records which are assigned to consignments for which the logistics company of the user is responsible and/or to transport units of this logistics company are selectable. This is advantageous, inter alia, in a client-server architecture in which the server(s) make(s) the method according to the invention available to a plurality of users, for example dispatchers of different logistics companies, in order to ensure that each user can access only his own logistics data records.

According to an embodiment of the method according to the invention, the search criterion comprises a character sequence entered by the user or consists thereof. The character sequence may, for example, comprise a placeholder (for example a wildcard) for truncation, but also not stand alone. The placeholder may, for example, stand for one or more specific or arbitrary characters. The character string may, for example, also contain more than one placeholder. The search area is enlarged due to the truncation. This is advantageous, inter alia, for outputting information relating to all logistics data records with the truncated character sequence as the result of a search query. The logistics data records can then be selected, for example, through a comparison of the character sequence with the parameters comprised in each case by the logistics data records and through a matching of the search region with the mobile position assigned or assignable to the logistics data records.

According to an embodiment of the method according to the invention, the character sequence comprises at least a part of an identifier of one or more consignments and/or transport units and/or logistics companies. Examples of an identifier are a consignment number of a consignment, an inventory number of a transport unit, a chassis number, a vehicle registration number and the like. This is advantageous, inter alia, in order to output information relating to all logistics data records which are assigned to a consignment and/or transport unit with at least the part of the identifier as the result of a search query. The logistics data records can then be selected, for example, through a comparison of the character sequence with the identifiers of the consignments and/or transport units respectively assigned to and comprised in the logistics data records and through a matching of the search region with the mobile position assigned or assignable to the logistics data records.

According to an embodiment of the method according to the invention, the search criterion comprises a consignment type, a transport unit type, an identification of a freight forwarder and/or a time-related criterion. Examples of possible consignment types are security consignment, sea freight, air freight, registered post and temperature-sensitive consignments. Examples of possible transport unit types are an HGV, a car, ship, aircraft, transporter, train, railway carriage, container and swap body. Examples of possible time-related criteria are the time since departure, the time to (scheduled or probable) arrival and the (known) delay which has already occurred. The logistics data records can then be selected, for example, through a comparison of the search criterion with parameters respectively comprised by the logistics data records, of the consignments and/or transport units assigned to the respective logistics data record and through a matching of the search region with the mobile position assigned or assignable to the logistics data records.

Obviously, a linking of different search criteria and/or character sequences is also conceivable as a search query of a user.

According to an embodiment of the method according to the invention, the selected data records comprise one or more consignment-tracking data records or are assigned or assignable to the latter, wherein each of the consignment-tracking data records comprises the last known position of a consignment. As explained above, the mobile position of a consignment can be updated in a database, for example, at regular or irregular time intervals. The current position of the consignment is, for example the last-updated position. The last known position of a consignment is, for example, the last scan position that the consignment has passed. Furthermore, each of the consignment-tracking data records may comprise, for example, the identifier of the assigned consignment and/or the consignment type. The consignment-tracking data records are, for example, stored in a consignment-tracking database.

According to an embodiment of the method according to the invention, the last known position of a consignment is the last known position of a transport unit which transports the consignment. For example, the consignment-tracking data record of the consignment is linked to the telematics data record of the transport unit in such a way that the position assigned or assignable to the telematics data record of the transport unit is also assigned or assignable to the consignment-tracking data record. The consignment-tracking data record may, for example, be linked manually or automatically to the telematics data record. For example, the consignment-tracking data record of a consignment can be linked to the telematics data record of a transport unit if the consignment is scanned on the loading ramp of the transport unit. This is advantageous, inter alia, in order to be able to track consignments which do not have their own position transmitter.

According to an embodiment of the method according to the invention, the selected logistics data records comprise one or more telematics data records or are assigned or assignable to the latter, wherein each of the telematics data records comprises the last known position of a mobile transport unit. Furthermore, each of the telematics data records may, for example, comprise the identifier of the assigned transport unit and/or the transport unit type. The telematics data records are, for example, stored in one or more telematics databases. For example, the telematics data records are stored in telematics databases of different providers. For example, the telematics data records are stored in telematics databases of different transport unit manufacturers. For example, the telematics data records are stored in a vehicle fleet database of the logistics company of the user.

According to an embodiment of the method according to the invention, the last known position of a mobile transport unit is the current position of the transport unit. As explained above, the mobile position of a mobile transport unit may, for example, be updated in a database at regular or irregular time intervals. The current position of the transport unit is, for example, the last-updated position.

According to an embodiment of the method according to the invention, the data sources comprise one or more (onvehicle) position transmitters, position databases, telematics databases, vehicle fleet databases, stationary or mobile consignment control stations, consignment-tracking databases and/or logistics databases.

According to an embodiment, the system according to the invention comprises one or more data sources and/or one or more data interfaces for accessing the data sources.

According to an embodiment, the apparatus according to the invention comprises a network interface for the connection to a network. A network interface is, for example, a wirebound network interface, such as an Ethernet network interface or a DSL modem, or a wireless network interface, such as a UMTS network interface or an IEEE 802.11 network interface. The network is, for example, a local area network, a wide area network, a virtual network, a radio network, a telephony network and/or the Internet.

The example of a method according to the invention, the example of an apparatus according to the invention, the example of a system according to the invention, the example of a program according to the invention and the example of a storage medium according to the invention and their embodiments therefore enable, inter alia, a geo-semantic search in geo-based logistics data records (and/or general geo-based information). Since a user already has specific geo-based information delimiting the search region in part before the search query, it is advantageous for both the performance and the user-friendliness of a search to use this specific information of the user automatically. This is achieved, for example, through the automatic assignment of a search region (and/or general geographical information) to a search query.

The features of the described example of a method according to the invention and its embodiments are also intended to be understood as disclosed in all possible combinations with one another. The features described for the example of a method according to the invention and its embodiments are also intended to be understood accordingly as disclosed (in turn in all possible combinations) for the example of an apparatus according to the invention, the example of a system according to the invention, the example of a program according to the invention and for the example of a storage medium according to the invention.

Further advantageous examples of designs of the invention can be found in the following detailed description of a number of examples of embodiments of the present invention, in particular in conjunction with the figures. However, the figures are intended for clarification purposes only, but not for determining the scope of protection of the invention. The figures are not true-to-scale and are intended only to reflect the general concept of the present invention by way of example. In particular, features contained in the figures are not intended in any way to be regarded as a necessary component of the present invention.

### BRIEF DESCRIPTION OF THE DRAWINGS

In the figures show:

FIG. 1: a block diagram of an example embodiment of a system according to the invention;

FIGS. 2a and 2b: a block diagram of an example embodiment of a server and a client;

FIGS. 3a to 3f: schematic representations of a map extract displayed on the display unit of the client:

FIGS. 4a to 4d: flow diagrams with method steps of example embodiments of the method according to the invention; and

FIG. 5: a block diagram of an example embodiment of a storage medium according to the invention.

### DETAILED DESCRIPTION OF SOME EXAMPLE EMBODIMENTS OF THE INVENTION

The present invention is described below with reference to example embodiments.

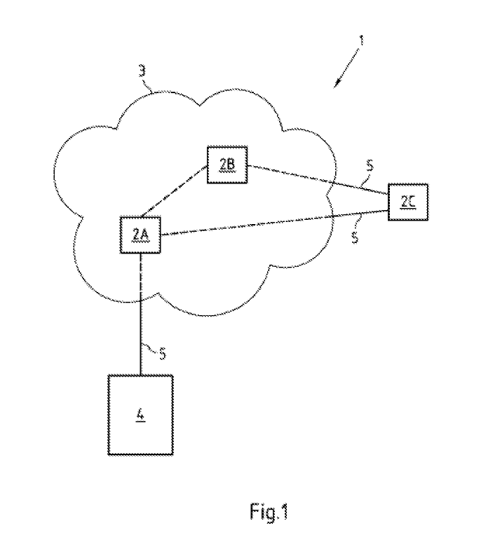

FIG. 1 shows a block diagram of an example embodiment of a system 1 according to invention. The system 1 comprises, inter alia, servers 2A, 2B and 2C.

The server 2A is an application server of a search service provider and makes a search service available for one or more users. The server 2B is a database server of the search service provider and makes a consignment-tracking database with consignment-tracking data records available for the users of the search service. The servers 2A and 2B are part of a computer cloud 3. Along with the servers 2A and 2B, the computer cloud 3 may comprise further servers, for example for providing the search service and/or further services.

The server 2C is a database server of a telematics service provider different from the search service provider and makes a telematics database with telematics data records available for one or more users.

The client 4 belongs to a user of the search service and the telematics service and is connected via a network 5 at least to the server 2A and/or the computer cloud 3. The client 3 is preferably a personal computer, a portable computer or a thin client.

The server 2C is similarly connected via the network 5 at least to the server 2A and/or the computer cloud 3. The network 5 is preferably the Internet.

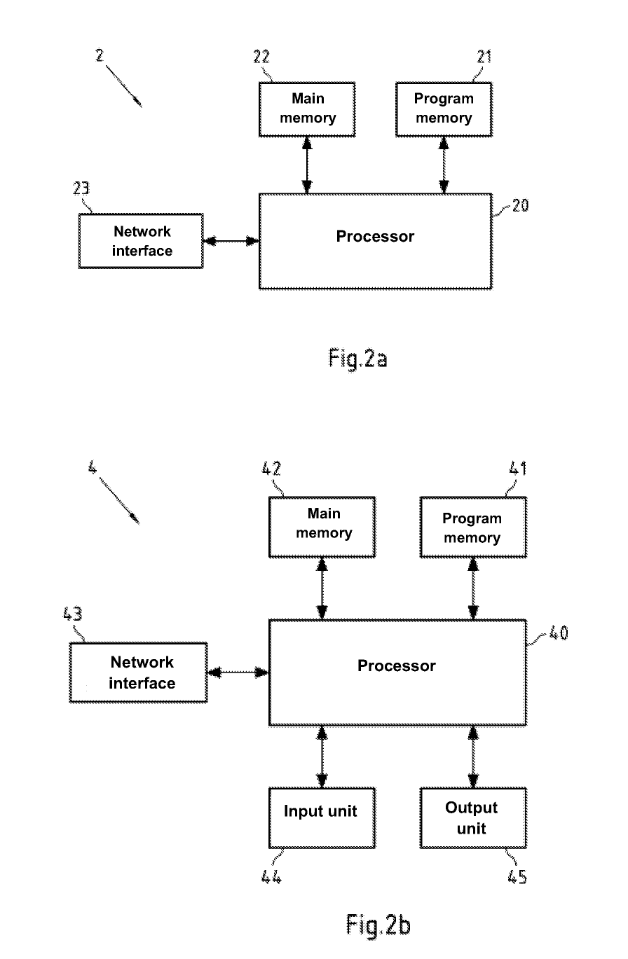

FIG. 2A shows a block diagram of an example embodiment of the server 2A. The server 2A is an example embodiment of an apparatus according to the invention.

The processor 20 of the server 2A executes program instructions which are stored in the program memory 21, and stores, for example, intermediate results or the like in the main memory 22. Furthermore, the processor 20 controls the network interface 23 via which the server 2A connects to the network 5.

Furthermore, the server 2A may have further units, such as, for example an input and/or output unit, e.g. a keyboard, a mouse, a display unit (an LCD display and/or LED indicator lights), a microphone, a touch-sensitive display unit, a loudspeaker, a biometric sensor (e.g. a fingerprint sensor) and/or a camera.

The block diagram of an example embodiment of the server 2B and/or the server 2C may correspond to the block diagram of the example embodiment of the server 2A. The servers 2B and 2C are configured, in particular, to be able to store and administer a large number of logistics data records. The servers 2B and 2C have, for example, a comprehensive memory for this purpose.

FIG. 2B shows a block diagram of an example embodiment of the client 4.

The processor 40 of the client 4 executes program instructions which are stored in the program memory 41, and stores, for example, intermediate results or the like in the main memory 42. Furthermore, the processor 40 controls the network interface 43 via which the client 4 can connect to the network 5 (see FIG. 1).

The client 4 furthermore comprises an input unit 44 and a display unit 45. The input unit 44 may, for example, accept user inputs and forward them to the processor 40. The display unit 45 can receive and output information for the user of the processor 40. The input unit 44 is preferably a mouse and/or keyboard, and the display unit 45 is preferably a monitor.

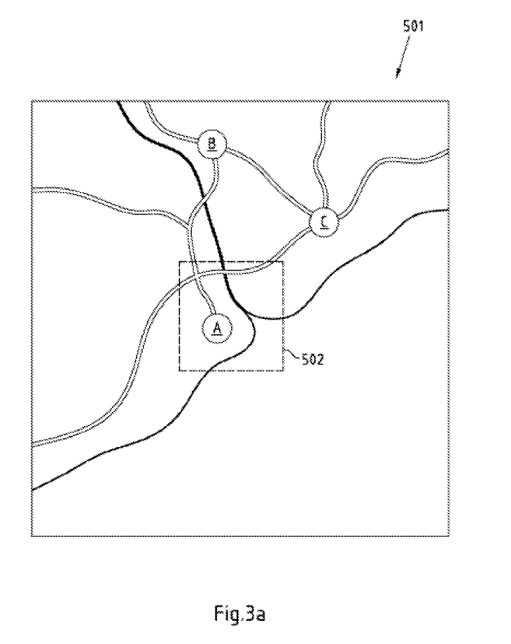

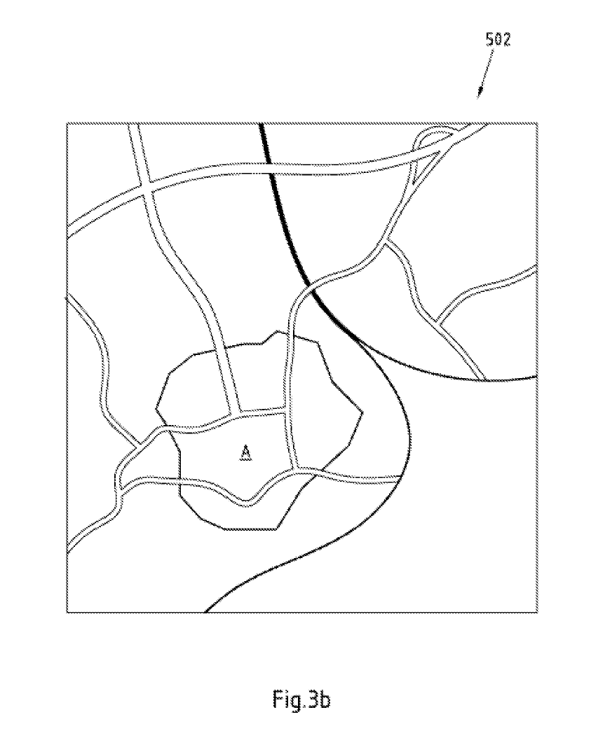

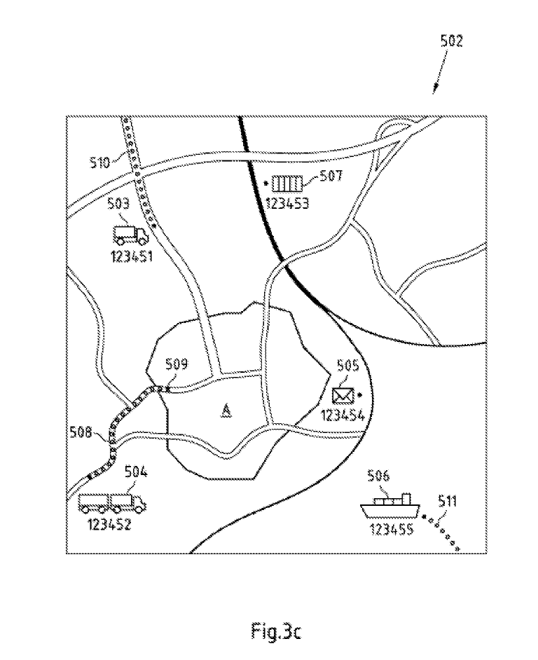

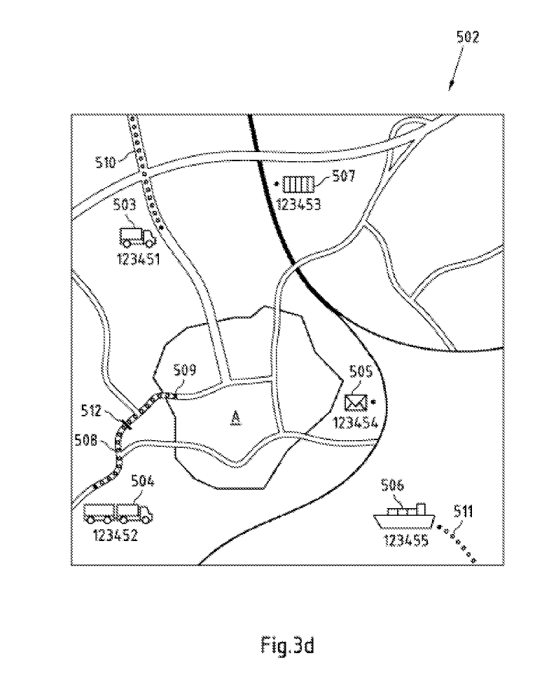

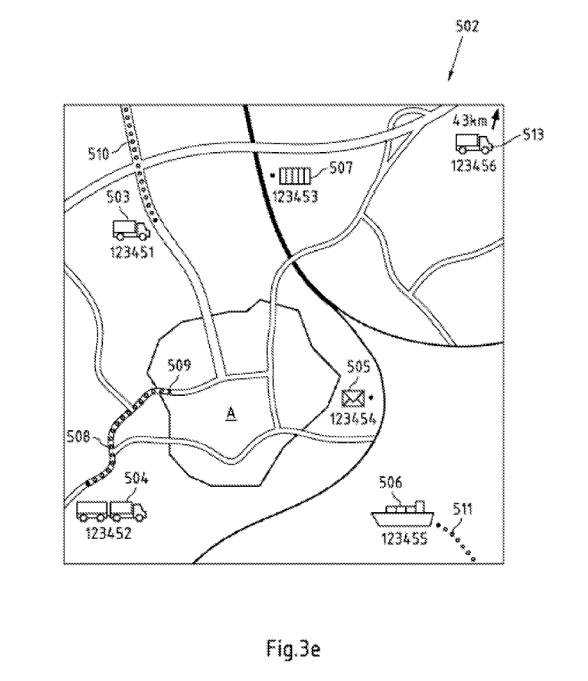

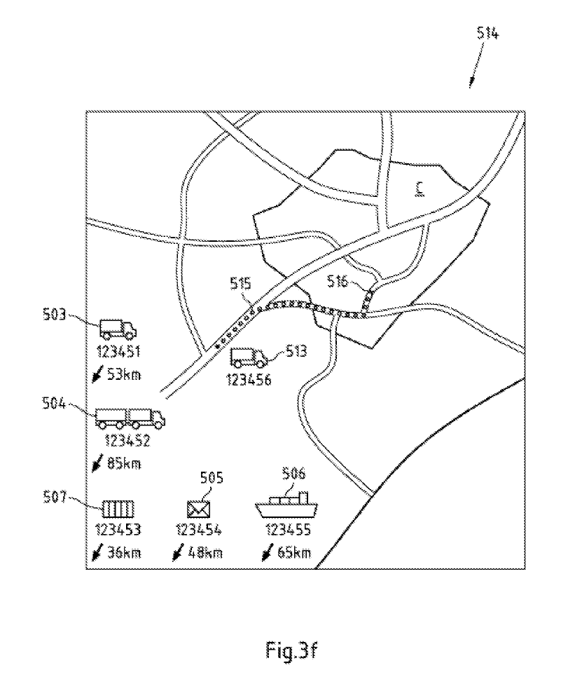

FIGS. 3a to 3f show schematic representations of a map extract displayed on the display unit 45 of the client 4. The map extracts are made available to the client 4, for example, as a displayable graphic by a server of the search service provider, for example the server 2A.

FIG. 3a shows a map extract 501. The position of the locations A, B and C and their surroundings is shown in the map extract 501. In the surroundings of the locations A, B, and C, the map extract 501 shows, inter alia, roads, a river, and a sea.

The map extract 501 is displayed to a user of the client 4, for example, by default when the user logs in to the server 2A of the search service provider. For example, the user, as a dispatcher of a logistics company, is responsible for consignments and/or transport units in the part of the earth's surface shown by the map extract 501. For example, the map extract 501 (or information identifying the latter) is stored as a default map extract in the user data of the user in a user database of the search service provider.

FIG. 3b shows a map extract 502. The map extract 502 has a larger scale than the map extract 501 and shows the surroundings of the location A. More details are shown in the map extract 502 than in the map extract 501. For example, the outline of the location A is identifiable and more roads are shown than in the map extract 501.

FIG. 3c shows pictograms 503 to 507 on the map extract 502 which are assigned to mobile units, such as consignments and transport units. The pictograms 503 to 507 are arranged on the map extract 502, in each case correctly oriented according to the current position of the assigned mobile unit and contain, for example, information relating to the unit, such as the identifier and the type. The type of the unit may, for example, be derived from the graphical representation of the pictogram. For example, the pictogram 503 is assigned to the HGV with chassis number 123451, the pictogram 504 to the HGV with trailer with chassis number 123452, the pictogram 505 to the letter with the consignment number 123454, the pictogram 506 to the container ship with the identifier 123455, and the pictogram 507 to the container with the inventory number 123453.

For the HGV with trailer with chassis number 123452, the planned route 508 and the destination point 509 are furthermore shown on the map extract 502 in FIG. 3c along with the pictogram 503. For the HGV with chassis number 123451, the planned route 510 is furthermore shown on the map extract 502 in FIG. 3c and, for the container ship with the identifier 123455, the planned route 511.

In FIG. 3d, a pictogram 512 is arranged on the map extract 502 along with the pictograms 503 to 507 shown in FIG. 3c. The pictogram 513 is assigned to a road closure along the planned route 508 of the HGV with trailer with chassis number 123452.

In FIG. 3e, a pictogram 513 is arranged on the map extract 502 along with the pictograms 503 to 507 shown in FIG. 3c. The pictogram 513 is assigned to the HGV with chassis number 123456. However, the current position of the HGV with chassis number 123456 is not located within the part of the earth's surface shown by the map extract 502, so that the pictogram 513 is arranged at the edge of the map extract 502 together with a direction arrow and a distance indication. In this case, the HGV with chassis number 123456 is, for example, at a distance of 43 km from the edge of the part of the earth's surface shown by the map extract 502 in the direction of the direction arrow.

FIG. 3f shows a map extract 514. The map extract 514 has, for example, the same scale as the map extract 502 and shows the surroundings of the location C. The current position of the HGV with chassis number 123456 assigned to the pictogram 513 is located within the part of the earth's surface shown by the map extract 514, so that the pictogram 513 is arranged correctly oriented according to the current position of the HGV with chassis number 123456 on the map extract 514. Furthermore, the planned route 515 and the destination point 516 of the HGV with chassis number 123456 are shown on the map extract 514.

However, the current position of the mobile units respectively allocated to the pictograms 503 to 507 is not located within the part of the earth's surface shown by the map extract 514, so that the pictograms 503 to 507 are then arranged at the edge of the map extract 514 together with a direction arrow and a distance indication.

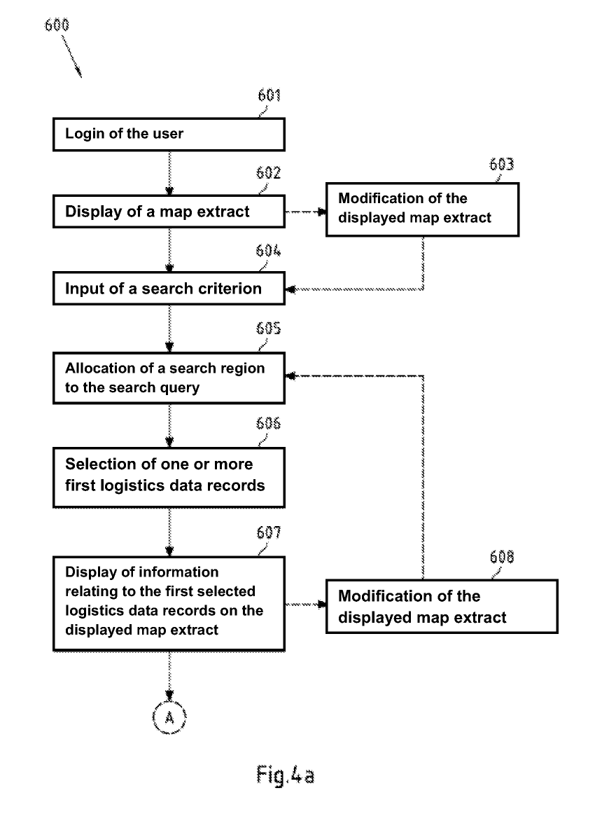

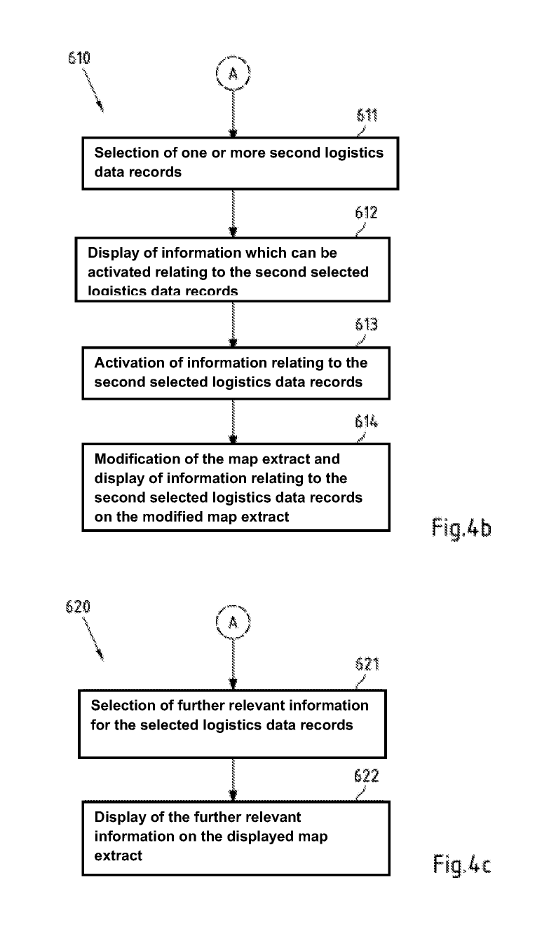

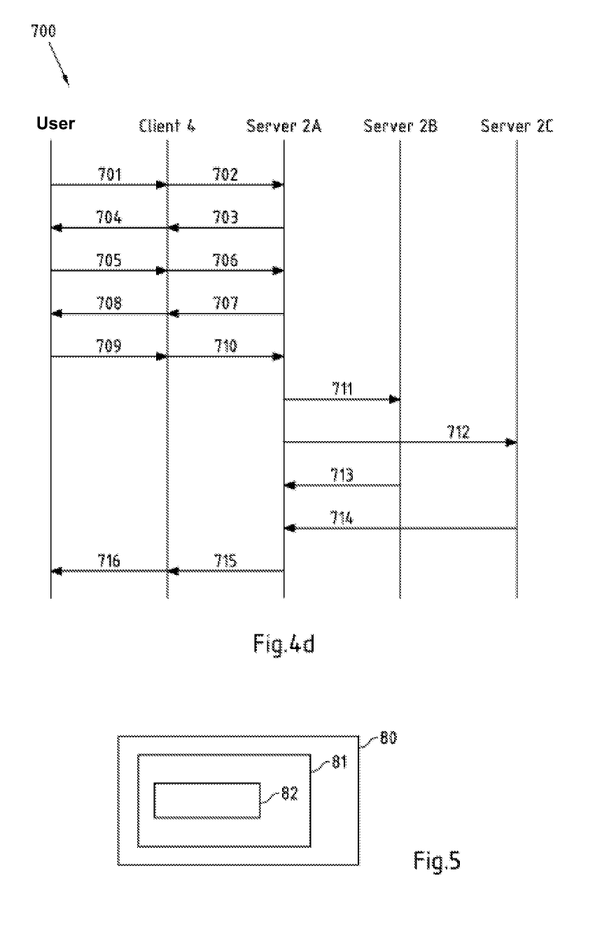

FIGS. 4a to 4d show flow diagrams 600, 610, 620 and 700 with method steps of example embodiments of the method according to the invention. The steps in the flow diagrams, which can be executed by a program, are intended to be understood in particular in such a way that a program contains corresponding program instructions which cause an apparatus on the processor of which the program is executed to carry out a corresponding step. The processor may control for example one or more corresponding means for carrying out a step. The method steps of the flow diagrams may be carried out here by one apparatus only, or by a plurality of apparatuses (the method steps/program instructions are therefore then also executed by the respective processors of the apparatuses). The last-mentioned case is described in detail below with reference to the flow diagram 700 of FIG. 4d for the steps 601-607 of the flow diagram 600 of FIG. 4a.

FIG. 4a shows a flow diagram 600 with method steps of an example embodiment of the method according to the invention.

In step 601, the user logs in to a search service provider for logistics data records. Here, the user enters, for example, his username and his password for the search service provider. A user input may, for example, be effected via the input unit 44 of the client 4. These authentication data are authenticated by the search service provider, for example through a matching with user data in a user database of the search service provider. The matching with the user data in a user database of the search service provider may, for example, be carried out by the server 2A of the search service provider.

Following the login of the user, a map extract is displayed to the user in step 602. For example, the map extract 501 shown in FIG. 3a is displayed. As explained above, the map extract 501 is displayed to the user, for example, by default when the user logs in to the search service provider. A map extract may, for example, be displayed on the display unit 45 of the client 4.

Furthermore, the user can modify, for example reduce, enlarge and/or move, the displayed map extract in an optional step 603 by means of a user input. For example, the user can select, in the map extract 501 displayed by default and shown in FIG. 3a, the enlarged map extract 502 shown in FIG. 3b for display. The map extract 502 shown in FIG. 3b is then displayed to the user.

In step 604, the user enters a search criterion for a search query. For example, the user enters the truncated search term “12345*” as the search criterion. The “*” in the truncated search term is a placeholder character for any number of further characters. The search term “12345*” therefore applies, for example, to the following character sequences: “123450”, “12345ABC” and “123456789”.

In step 605, a search region is automatically assigned to the search query. The search region is determined from the map extract displayed at the time of the input of the search criterion. This is, for example, the map extract 502 shown in FIG. 3b. The search region is assigned to the search query by a logical linking of the search criterion entered by the user to a representation of the search region. For example, the search criterion is linked to an interval of the corresponding geographical latitude and longitude data. The search query then reads, for example, as follows: “12345* in Lat: 41.11221 to 41.11110 and Long: 56.000 to 56.421”. All logistics data records allocated to mobile units which are moving or have moved in the search region, and those beginning with the number “12345” would, for example, thus be selected as the result of the search query.

Furthermore, the search criterion entered by the user is, for example, linked automatically to the user in such a way that the result of the search query is restricted to logistics data records which the user is authorised to view. The search query then reads, for example, as follows: “12345* in Lat: 41.11221 to 41.11110 and Long: 56.000 to 56.421 where tracking type equals customer account”.

In step 606, first logistics data records to which the search criterion applies and which are assigned to a mobile unit, the current position of which is located in the search area, are selected according to the search query. The selection may be carried out, for example, by the database servers 2B and 2C.

For example, telematics data records and consignment-tracking data records are selected which in each case comprise an identifier and the current position of the mobile unit assigned to the respective data record. Furthermore, the selected telematics data records may, for example, in each case comprise the planned route and the destination point of the assigned transport unit. For example, for the aforementioned search term, first telematics data records are selected which are assigned to the HGV with chassis number 123451, the HGV with trailer with chassis number 123452 and the container ship with the identifier 123455. For example, for the aforementioned search term, first consignment-tracking data records are furthermore selected which are assigned to the letter with the consignment number 123454 and to the container with the inventory number 123453.

Information relating to the first selected logistics data records can then be produced as the first result of the search query. For example, a first additional presentation level for the map extract 502 shown in FIG. 3b is produced as the first result of the aforementioned search query from the first selected telematics data records and the first selected consignment-tracking data records with the pictograms 503 to 507. Furthermore, the first additional presentation level for the first selected telematics data records may contain, for example, the planned routes 508, 510 and 511 and the destination point 509. The first additional presentation level may, for example, be laid over the map extract 502 in FIG. 3b in such a way that the display shown in FIG. 3c is produced.

In a step 607, the information relating to the first selected logistics data records is displayed as the first result of the search query. For example, the display shown in FIG. 3c is displayed on the display unit 45 of the client 4.

In an optional step 608, the user can modify, for example reduce, enlarge and/or move, the displayed map extract by means of a user input. In this case, the method jumps back to step 605 and a modified search region is automatically assigned to the search query. As explained for step 605, the modified search region is determined from the modified displayed map extract. The steps 608 and 607 then run again.

FIG. 4b shows a flow diagram 610 with optional method steps of an example embodiment of the method according to the invention. The steps 611-614 contained in the flow diagram 610 may, for example run temporally after one of the method steps 606 to 608 of the flow diagram 600.

In an optional step 611, second logistics data records can be selected to which the search criterion applies and which are assigned to a mobile unit, the current position of which is not located in the search region. The selection may, for example, be carried out by the database servers 2B and 2C. For example, a second telematics data record which is assigned to the HGV with chassis number 123456 is selected for the aforementioned search term.

Information relating to the second selected logistics data records can then be produced as the second result of the search query. For example, a second additional presentation level is produced for the map extract 502 shown in FIG. 3b with the pictogram 513 as the second result of the aforementioned search query from the second selected telematics data record. The second additional presentation level may, for example, be laid over the map extract 502 shown in FIG. 3c in such a way that the display shown in FIG. 3e is produced.

In an optional step 612, the information relating to the second selected logistics data records can be displayed as an activatable second result of the search query. For example, the display shown in FIG. 3e is displayed on the display unit 45 of the client 4. The pictogram 513 can, for example, be activated by a user input in such a way that, following the activation, a map extract is shown which shows a part of the earth's surface within which the current position of the HGV assigned to the pictogram 513 with chassis number 123456 is located. For example, the pictogram 513 is a hyperlink.

In an optional step 613, the user can activate information relating to the second selected logistics data records. For example, the user can activate the pictogram 513.

The displayed map extract is then modified in an optional step 614 in such a way that the activated information relating to the second selected logistics data records can be arranged on the modified map extract. The activated information is displayed on the modified map extract. For example, the current position of the HGV with chassis number 123456 assigned to the pictogram 513 is located within the part of the earth's surface shown by the map extract 514. If the user has activated the pictogram 513 in step 613, the display shown in FIG. 3f is thus displayed to him in step 613 on the display unit 45 of the client 4.

FIG. 4c shows a flow diagram 620 with optional method steps of an example embodiment of the method according to the invention. The steps 621-622 contained in the flow diagram 620 may, for example, run temporally after one of the method steps 607 and 608 of the flow diagram 600 or 614 of the flow diagram 610 and/or temporally before the method steps 611 of the flow diagram 610.

In an optional step 621, further relevant information can be selected for the selected logistics data records. The selection of the further information may, for example, be carried out depending on the selected logistics data records and the search region. For example, only further information which is assigned and/or assignable to a position which is located in the search region and which is relevant to the selected logistics data record may be selected. The further information may, for example, be selected and displayed automatically. The further information may, for example, be selected and displayed on the basis of a user input.

For example, traffic information and weather information are relevant to the aforementioned first selected logistics data records. For example, only traffic information which is assigned to a position in the search region, and only for positions along the planned routes 508 of the HGV with trailer with chassis number 123452 and the planned route 510 of the HGV with chassis number 123451 is selected. Furthermore, only weather information which is assigned to a position in the search region, and only along the planned route 511 of the container ship with the identifier 123455 is selected. For example, only traffic information for the planned route 508 of the HGV is present, i.e. a road closure, so that, for example, a further additional presentation level for the map extract 502 shown in FIG. 3b is produced with the pictogram 512.

In an optional step 622, the further relevant information can be displayed on the displayed map extract. For example, the display shown in FIG. 3d is displayed on the display unit 45 of the client 4.

FIG. 4d shows a flow diagram 700 with method steps, which runs, for example, when the method steps 601 to 607 are carried out in the system 1.

In a step 701, the user enters his username and his password for the search service provider on the input unit 44 of the client 4.

In a step 702, the client sends these authentication data (via the network 5) to the server 2A. The server 2A receives the authentication data and authenticates the user, for example through a matching with user data in a user database of the search service provider on the server 2A.

In a step 703, the server 2A, when it has authenticated the user, sends a map extract to the client 4. For example, the map extract 501 shown in FIG. 3a is sent by the server 2A to the client 4 as a displayable graphic, for example as an image file. For example, the map extract 501 is sent by default to the client 4 when the user logs in on the server 2A of the search service provider. Alternatively, it is conceivable, for example, that the position of the user is known to the server 2A and the server 2A sends a map extract to the client 4 which shows a part of the earth's surface within which the user is located. For example, the server 2A can locate the position of the user or receive it from the client 4.

The client 4 receives the map extract and displays the map extract for the user in a step 704 on the display unit 45.

In a step 705, the user can modify, for example reduce, enlarge and/or move, the displayed map extract, as explained above for step 603. If, for example, the user selects for display the enlarged map extract 502 shown in FIG. 3b in the default map extract 501, a corresponding map extract request is sent to the server 2A in a step 706.

The server 2A receives the map extract request and, in a step 707, sends the map extract 502 selected by the user shown in FIG. 3b to the client. The client 4 receives the map extract 502 and displays the map extract for the user in a step 708 on the display unit 45, as shown in FIG. 3b.

Alternatively, it is also conceivable that the client requests the map extracts, for example, from a server of an external map service provider and receives them from the latter.

In a step 709, the user enters a search criterion for a search query on the input unit 44 of the client 4. As explained above for step 604, the user may, for example, enter the truncated search term “12345*” as the search criterion.

In a step 710, the client 4 sends the search query with the search criterion to the server 2A. The server 2A then automatically assigns a search region to the search query, as explained above for step 605. The server 2A determines the search region here from the last map extract request received from the client 4 or from the default map extract. This is, for example, the map extract 502 shown in FIG. 3b. The search query then reads, for example, as follows: “12345* in Lat: 41.11221 to 41.11110 and Long: 56.000 to 56.421”.

Alternatively, it is conceivable that the client 4 automatically assigns a search region to the search query, for example if the client requests the map extracts from a server of an external map service provider and receives them from the latter.

Furthermore, the search criterion entered by the user is, for example, linked automatically by the server 2A with the user in such a way that the result of the search query is restricted to logistics data records which the user is authorised to view. The search query then reads, for example, as follows: “12345* in Lat: 41.11221 to 41.11110 and Long: 56.000 to 56.421 where tracking type equals customer account”.

The search query is then sent by the server 2A in a step 711 to the server 2B and in a step 712 to the server 2C. The servers 2B and 2C process the search query, as explained above for step 606, and select the first logistics data records to which the search criterion applies and which are assigned to a mobile unit, the current position of which is located in the search region. For example, the server 2B selects the aforementioned first consignment-tracking data records and the server 2C selects the aforementioned first telematics data records.

In a step 713, the server 2B sends the first selected consignment-tracking data records to the server 2A, and, in a step 714, the server 2C sends the first selected telematics data records to the server 2A. The server then produces the information relating to the first selected logistics data records as the first result of the search query, as explained above for step 606. For example, the server produces the first additional presentation level as the first result of the search query.

In a step 715, the server 2A sends the first information produced as the result of the search query to the client 4. For example, the server 2A sends the first presentation level as a displayable graphic to the client 4.

In a step 716, the client displays the first information as the result of the search query on the display unit 45. For example, the client displays the display shown in FIG. 3c on the display unit 45 of the client 4.

FIG. 5 shows a block diagram of an example embodiment of a storage medium 80 according to the invention. The storage medium is preferably a computer-readable storage medium. The storage medium may, in particular, be a physical and/or tangible storage medium which is readable by at least one of the servers 2A, 2B and 2C and/or the client 4.

The storage medium 80 comprises a program 81 with program instructions 82. The program instructions 82 cause an apparatus, for example, to carry out at least partially at least some of the steps of the flow diagrams 600, 610, 620 and/or 700 when the program is executed on a processor of the apparatus. For example, the program is executable on at least one of the processors 20 and 40.

The sequence of the method steps in the individual flow diagrams described in this specification is not mandatory, alternative sequences of the method steps being conceivable. The method steps can be implemented in various ways, so that an implementation in software (through program instructions), hardware or a combination of both is conceivable for the implementation of the method steps.

1. Method, carried out by at least one apparatus, comprising
obtaining a search criterion for a search query of a user,
automatically assigning a search region to the search query,
selecting one or more logistics data records from one or more data sources in dependence on at least the search criterion and the search region, wherein a mobile position is one of assigned and assignable to each of the logistics data records, and wherein only logistics data records are selected to which the search criterion applies and the one of assigned and assignable position of which is located in the search region, and
outputting information relating to the selected logistics data records as a result of the search query.

2. The method according to claim 1, wherein the search region is determined from a map extract displayed to the user.

3. The method according to claim 2, wherein the map extract contains a known position of the user.

4. The method according to claim 2, wherein the map extract is at least one of selectable and modifiable by the user.

5. The method according to claim 2, wherein the search region is determined automatically and in such a way that at least one of the following holds:
a centre of the search region corresponds to a centre of the map extract, and
the search region corresponds to the map extract.

6. The method according to claim 2, wherein the information relating to the logistics data records is displayed on the map extract at the position that is one of assigned and assignable to the respective logistics data record, respectively.

7. The method according to claim 1, further comprising
selecting one or more further logistics data records from the data sources in dependence on at least the search criterion and the search region, wherein a mobile position is one of assigned and assignable to each of the further logistics data records, and wherein the further logistics data records are selected only if the search criterion applies to them and their one of assigned and assignable position is not located in the search region, and
outputting of information relating to the further logistics data records.

8. The method according to claim 1, further comprising at least one of:
automatically extending the search region for the search query if one of the following holds:
no logistics data record has been selected, and
the number of selected logistics data records falls below a threshold value, and
automatically reducing the search region for the search query if the number of selected logistics data records exceeds a threshold value.

9. The method according to claim 1, wherein the search criterion restricts the selectable logistics data records at least to logistics data records that are one of assigned and assignable to the user.

10. System, comprising
one or more apparatuses configured to carry out the method according claim 1.

11. A tangible storage medium comprising a program, the program comprising
program instructions for carrying out the method according to claim 1, when the program is executed on a processor.

12. An apparatus comprising at least one processor, and at least one memory storing a program comprising program instructions, wherein the memory and the program are configured at least to cause the apparatus, when the program is executed on the processor, to carry out the following:
obtaining a search criterion for a search query of a user,
automatically assigning a search region to the search query,
selecting one or more logistics data records from one or more data sources in dependence on at least the search criterion and the search region, wherein a mobile position is one of assigned and assignable to each of the logistics data records, and wherein only logistics data records are selected to which the search criterion applies and the one of assigned and assignable position of which is located in the search region, and
outputting information relating to the selected logistics data records as a result of the search query.

13. The apparatus according to claim 12, wherein the search region is determined from a map extract displayed to the user.

14. The apparatus according to claim 13, wherein the map extract contains a known position of the user.

15. The apparatus according to claim 13, wherein the map extract is at least one of selectable and modifiable by the user.

16. The apparatus according to claim 13, wherein the search region is determined automatically and in such a way that at least one of the following holds:
a centre of the search region corresponds to a centre of the map extract, and
the search region corresponds to the map extract.

17. The apparatus according to claim 13, wherein the information relating to the logistics data records is displayed on the map extract at the position that is one of assigned and assignable to the respective logistics data record, respectively.

18. The apparatus according to claim 12, wherein the memory and the program are further configured to cause the apparatus, when the program is executed on the processor, to carry out the following
selecting one or more further logistics data records from the data sources in dependence on at least the search criterion and the search region, wherein a mobile position is one of assigned and assignable to each of the further logistics data records, and wherein the further logistics data records are selected only if the search criterion applies to them and their one of assigned and assignable position is not located in the search region, and
outputting of information relating to the further logistics data records.

19. The apparatus according to claim 12, wherein the memory and the program are further configured to cause the apparatus, when the program is executed on the processor, to carry out one of the following:
automatically extending the search region for the search query if one of the following holds:
no logistics data record has been selected, and
the number of selected logistics data records falls below a threshold value, and
automatically reducing the search region for the search query if the number of selected logistics data records exceeds a threshold value.

20. The apparatus according to claim 12, wherein the search criterion restricts the selectable logistics data records at least to logistics data records that are one of assigned and assignable to the user.
